(19) United States
(12) Patent Application Publication
(10) Pub. No.: US 2015/0101901 A1
(43) Pub. Date: Apr. 16, 2015

(54) ANTI-VIBRATION DEVICE FOR VEHICLE

(71) Applicants: Nissan Motor Co., Ltd., Yokohama-shi, Kanagawa (JP); Bridgestone Corporation, Tokyo (JP)

(72) Inventors: Emi Tokunoh, Kawasaki-shi (JP); Takanobu Sugiyama, Yokohama-shi (JP); Masahiko Kondo, Yokohama-shi (JP); Koji Tanimura, Kawasaki-shi (JP); Akira Ueki, Kamakura-shi (JP); Fumiharu Kurose, Kakogawa-shi (JP); Motohiro Yanagida, Yokohama-shi (JP)

(21) Appl. No.: 14/395,839

(22) PCT Filed: Jun. 10, 2013
(86) PCT No.: PCT/JP2013/065945

§ 371 Date: Oct. 21, 2014

(30) Foreign Application Priority Data
Jun. 18, 2012 (JP) 2012-137190

(51) Int. Cl. F16F 7/10

(52) U.S. Cl. CPC F16F 7/1011
USPC 188/378

(57) ABSTRACT

A vehicular antivibration device includes a torque rod and an actuator. The torque rod is connected at a first end to a vehicle body and connected at a second end to a vibration source. The actuator is disposed between the first end and the second end of the torque rod, includes an inertia mass supported on the torque rod, and causes the inertia mass to reciprocate in the axial direction of the torque rod. The actuator includes a coil, a magnetic core, a permanent magnet and a heat-conducting member. The magnetic core forms magnetic paths for the coil, and the coil is wound around the outer periphery of the magnetic core. The permanent magnet faces the inertia mass and is disposed on the magnetic core. The heat-conducting member is disposed so as to contact the coil and the torque rod.

### CROSS-REFERENCE TO RELATED APPLICATIONS

This application is a U.S. National stage application of International Application No. PCT/JP2013/065945, filed Jun. 10, 2013, which claims priority to Japanese Patent Application No. 2012-137190 filed in Japan on Jun. 18, 2012, the contents of which are hereby incorporated herein by reference.

### BACKGROUND

1. Field of the Invention

The present invention relates to a vehicular antivibration device.

2. Background Information

Conventional linear actuators can include a stator and a mover that has an armature and is capable of reciprocating relative to the stator. The stator can include a permanent magnet facing the armature and have magnetic poles aligned along the reciprocating direction, and a pair of magnetic pole members disposed on both sides of the permanent magnet in the reciprocating direction (Japanese Laid-Open Patent Application No. 2003-235234).

### SUMMARY

A reciprocating type linear actuator for an active torque rod installed between an internal combustion engine of a vehicle and a vehicle body is effected not only by heat from the temperature of the atmosphere, but also by heat from the heat generation of the coils caused by the driving of the actuator. The heat energy when the actuator is driven is transferred to a stator core and a permanent magnet via a bobbin around which coils are wound, and is transferred to the torque rod via a shaft for coupling the actuator to the rod. However, to improve heat durability and reliability while using an inexpensive permanent magnet and a less costly actuator, heat transfer to the permanent magnet must be suppressed and heat must be dispelled to the torque rod more efficiently than in conventional practice.

The problem to be solved by the invention is to provide a vehicular antivibration device that can suppress heat transfer to the permanent magnet and efficiently dispel heat to the torque rod.

The present invention solves the above problem by providing a heat-conducting member between the coils of the actuator and the torque rod.

According to the present invention, because heat energy during driving generated by the coils is transferred directly to the torque rod via the heat-conducting member, heat transfer to the permanent magnet can be suppressed and heat can be efficiently dispelled to the torque rod.

### BRIEF DESCRIPTION OF THE DRAWINGS

Referring now to the attached drawings which form a part of this original disclosure.

FIG. 1 is a partially cut-away front view showing a vehicular antivibration device according to an embodiment of the present invention.

FIG. 2 is a partially cut-away front view showing a vehicular antivibration device according to another embodiment of the present invention.

FIG. 3 is a partially cut-away front view showing a vehicular antivibration device according to yet another embodiment of the present invention.

FIG. 4 is a partially cut-away front view showing a vehicular antivibration device according to yet another embodiment of the present invention.

FIG. 5 is a partially cut-away front view showing a vehicular antivibration device according to yet another embodiment of the present invention.

FIG. 6 is a partial enlarged cross-sectional view of the vehicular antivibration device of FIG. 1.

FIG. 7A is a partial enlarged cross-sectional view showing a vehicular antivibration device according to yet another embodiment of the present invention.

FIG. 7B is a view indicated by arrow VIIB of FIG. 7A.

### DETAILED DESCRIPTION OF THE EMBODIMENTS

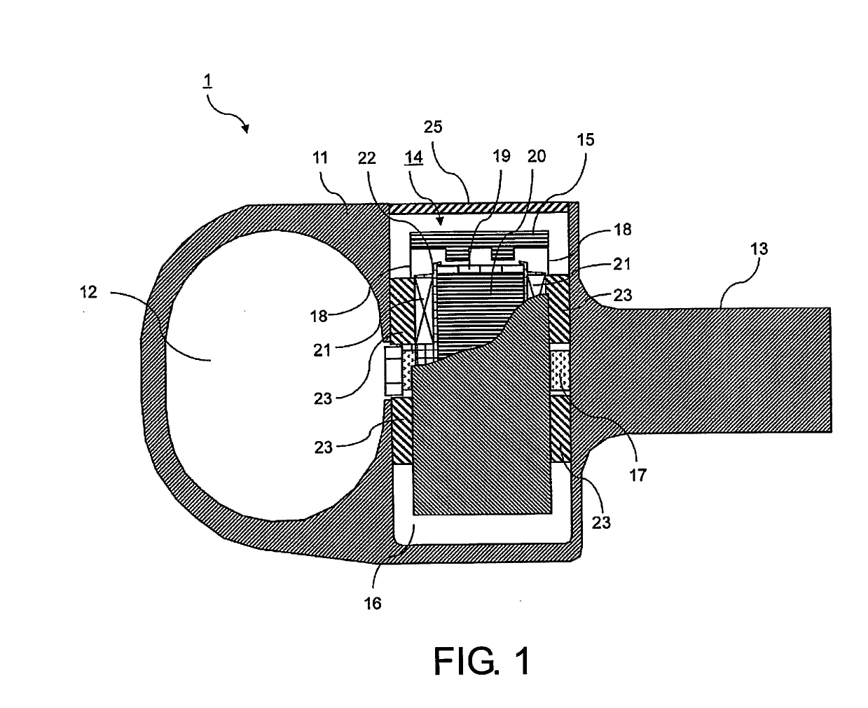

Embodiments of the present invention are described below based on the drawings. FIG. 1 is a partially cut-away cross-sectional view showing a vehicular antivibration device according to an embodiment of the present invention. The vehicular antivibration device 1 of the present example comprises a torque rod 11 in which a pair of bushes 12, 13 are disposed at both ends, and an actuator 14 (including an inertia mass 15) is accommodated in a housing 16. This torque rod 11 is rigidly linked between the bush 12 and the bush 13.

One of the pair of bushes 12, 13 is secured to an engine which is a vibration source, while the other is secured to a vehicle body, and the pair of bushes 12, 13 is linked to the engine or the vehicle body via an antivibration member (not shown in the drawings) configured from elastic rubber or the like having the functions of both a spring and an attenuator.

The actuator 14 of the present example is accommodated in the housing 16 formed between the bushes 12, 13 of the torque rod 11, and a shaft 17 of the actuator 14 is secured to the torque rod 11 on a straight line joining the substantial centers of the bushes 12, 13 in the housing 16. The axial direction of the shaft 17 (the left-right direction of FIG. 1) is the direction of the reciprocating movement of the inertia mass 15. The housing 16 is closed up (waterproofed) by a lid 25 after accommodating the actuator 14 so that even if the torque rod 11 in the engine room were to be covered in water from raindrops getting inside or mud from mud splatters or soil, the actuator 14 would not be wetted by water or fouled by mud.

The inertia mass 15, which is composed of a magnetic metal or the like, is disposed around the periphery of the shaft 17 on the same axis as the shaft 17. A cross section of the inertia mass 15, as seen from the axial direction of the shaft 17, has a point-symmetrical shape about the center (barycenter) of the shaft 17, and the barycenter of the inertia mass 15 coincides with the center of the shaft 17. The inertia mass 15 is in the shape of a square tube, and the axial-direction ends (the left and right ends in FIG. 1) of the shaft 17 of the inertia mass 15 are both linked to the shaft 17 via elastic support springs 18. The elastic support springs 18 are plate springs having comparatively low rigidity, for example. Part of an inner wall 15a of the inertia mass 15 is made to be convex toward a permanent magnet 19 of the actuator 14, described hereinafter.

In the vehicular antivibration device 1 of the present example, the actuator 14 is disposed in the space between the inertia mass 15 and the shaft 17. The actuator 14 is a linear type (linear motion type) actuator including a square tube shaped magnetic core 20, coils 21, bobbins 22 around which the coils 21 are wound, and the permanent magnet 19; and the actuator causes the inertia mass 15 to reciprocate along the axial direction of the shaft 17.

The magnetic core 20 constituting the magnetic paths of the coils 21 is configured from stacked steel plates, and is secured to the shaft 17. The magnetic core 20 is divided into a plurality of members before the vehicular antivibration device 1 is assembled, and these members are adhered to the periphery of the rod-shaped shaft 17 by an adhesive, thereby forming the square tube shaped magnetic core 20 as a whole. The bobbins 22 are provided so as to surround the square tube shaped magnetic core 20, and the coils 21 are wound around the bobbins 22. The permanent magnet 19 is disposed on the outer peripheral surface of the magnetic core 20.

Because the actuator 14 has this manner of configuration, the inertia mass 15 is driven so as to reciprocate linearly, i.e. in the axial direction of the shaft 17 of the inertia mass 15, by reactance torque resulting from the magnetic field generated by the coils 21 and the permanent magnet 19.

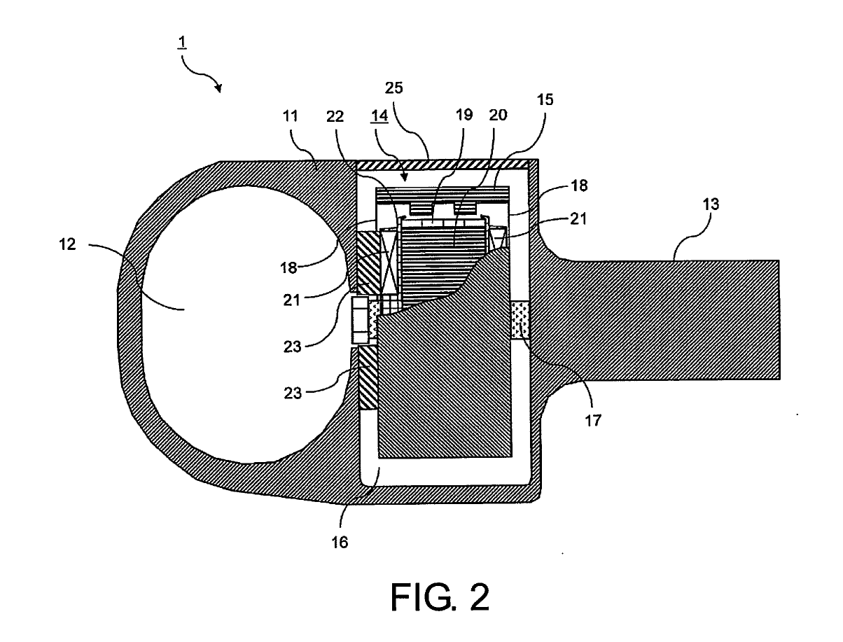

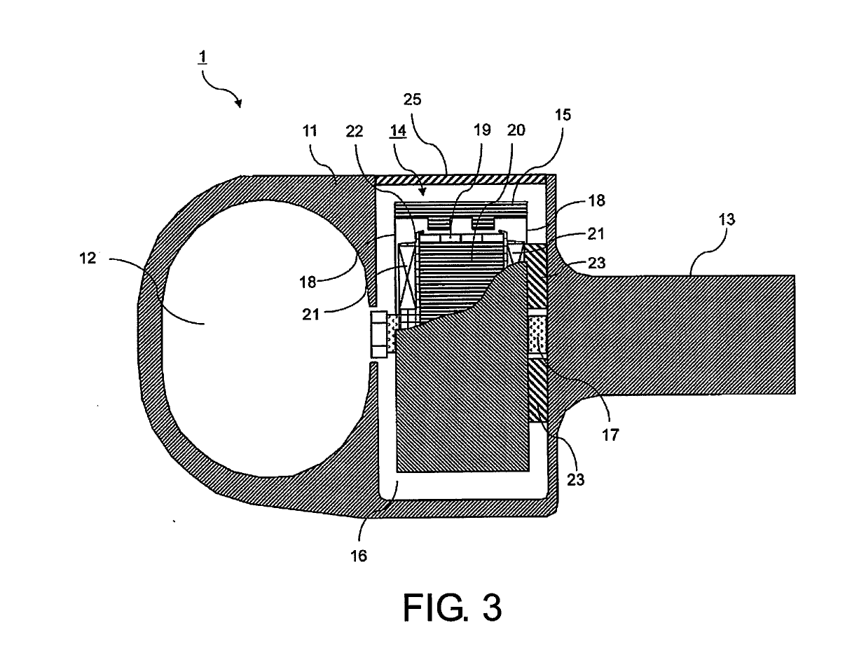

The air between the inner wall of the housing 16 and the coils 21 is hermetically sealed in and intrinsically does not transfer heat readily, and the heat produced by the coils 21 is therefore primarily transferred once to the shaft 17, further transferred via the shaft 17 to the torque rod 11 by the inner wall surface of the housing 16, and radiated to the exterior by the outer surface of the torque rod 11. However, when heat radiation via the shaft 17 in this manner is the subject, there is a risk that when there is a large load on the coils 21, heat radiation will not necessarily be sufficient and the performance and durability of the actuator will decrease. In the vehicular antivibration device 1 of the present example, heat-conducting members 23 composed of a heat-conductive metal or non-metal material are interposed between the coils 21 and the inner peripheral surface of the housing 16 of the torque rod 11. In the example shown in FIG. 1, the heat-conducting members 23 are interposed on the bush 12 and bush 13 sides, in the spaces between the coils 21 wound around the bobbins 22 at both the top and bottom of the shaft 17 and the inner wall surface of the housing 16, but the heat-conducting member 23 may be provided to the bush 12 side alone as shown in FIG. 2, or the heat-conducting member 23 may be provided to the bush 13 side alone as shown in FIG. 3.

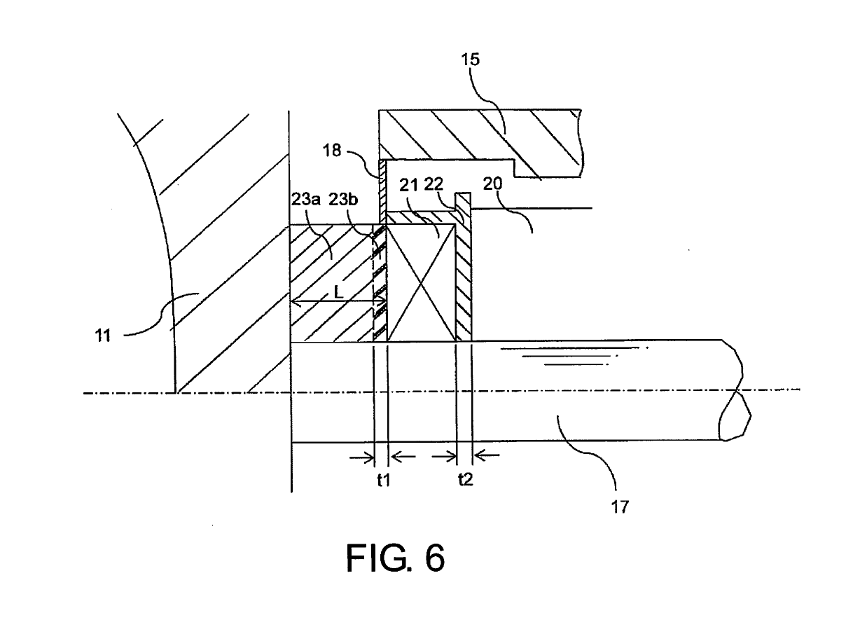

The heat-conducting members 23 are not particularly limited as long as they are made of a high heat-conductive material, and either a metal material such as aluminum or a non-metal material such as rubber or a resin can be used. The surfaces that come in contact with the coils 21 are preferably configured from an insulating material in order to reliably prevent short circuiting with the coils 21. As shown in FIG. 6, for example, first portions 23a on the sides in contact with the inner wall surface of the housing 16 of the torque rod 11 may be configured from a metal material such as aluminum, and second portions 23b on the sides in contact with the coils 21 may be configured from an insulating material such as rubber or a resin. In this case in particular, the thickness t1 of the insulating material such as rubber or a resin of the second portions 23b on the sides in contact with the coils 21 is formed to be less than the thickness t2 of the bobbins 22, whereby the heat energy generated by the coils 21 can be better dispelled to the torque rod 11.

When the heat-conducting members 23 of the present example are interposed between the coils 21 and the inner wall surface of the housing 16 of the torque rod 11, the dimension L from the contact surface of the torque rod 11 shown in FIG. 6 to the contact surfaces of the coils 21 is preferably set on the basis of a dimension including a stack-up tolerance that is less than the design-center value of the torque rod 11 and the actuator 14. Doing so causes the dimension L from the contact surface of the torque rod 11 to the contact surfaces of the coils 21 to consistently be less than the thickness of the heat-conducting members 23; therefore, when the heat-conducting members 23 are interposed, the heat-conducting members 23 are firmly bonded to both the coils 21 and the inner wall surface of the housing 16, and heat conductivity is further increased.

To firmly bond the heat-conducting members 23 to both the coils 21 and the inner wall surface of the housing 16, in addition to the above-described dimension setting using the stack-up tolerance, the heat-conducting members 23 may be configured from an elastic material, and the elastic force thereof may be used to interpose the heat-conducting members between the coils 21 and the inner wall surface of the housing 16 of the torque rod 11. In cases in which the heat-conducting members 23 are instead configured from a non-elastic material, the heat-conducting members 23 may be pressure-fitted in between the coils 21 and the inner wall surface of the housing 16 of the torque rod 11.

Returning to FIG. 1, the heat-conducting members 23 and the coils 21 shown in this drawing are configured as separate components, but a molding resin may be integrally molded on the coils 21, and the coils 21 and heat-conducting members 23 may be integrally formed. Doing so guarantees adhesion between the coils 21 and the heat-conducting members 23 and makes it possible to increase heat conductivity with a simple manufacturing method.

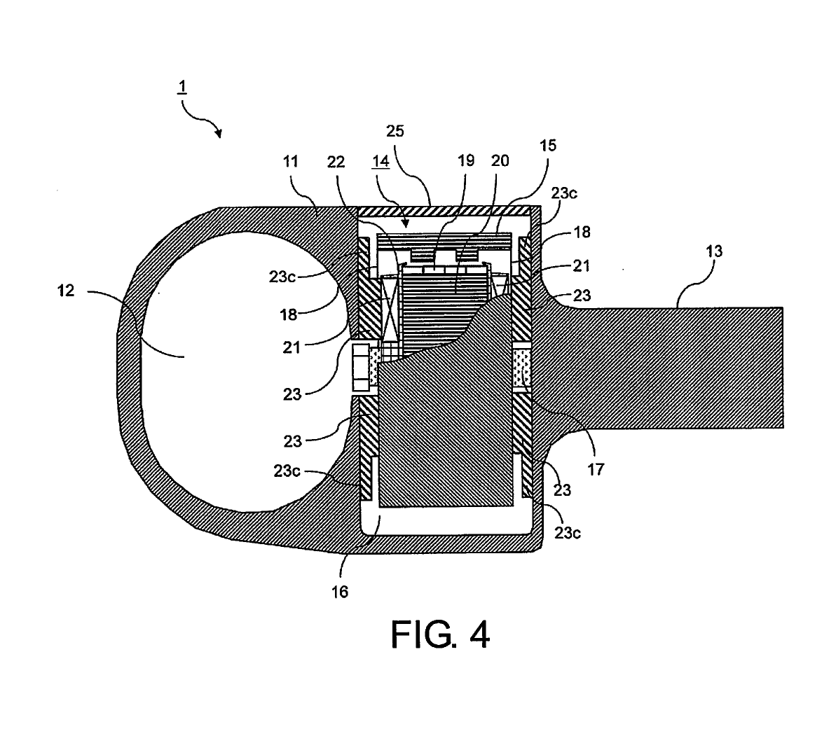

FIG. 4 is a partially cut-away cross-sectional view showing a vehicular antivibration device 1 according to another embodiment of the present invention. The shapes of the heat-conducting members 23 are different from those of the embodiments described above, but the configuration is otherwise similar. Specifically, the heat-conducting members 23 of the present example are similar to those of the embodiments described above in that the surfaces at one end are in contact with the coils 21 while the surfaces at the other end are in contact with the inner wall surface of the housing 16, but the heat-conducting members 23 of the present example have stopper parts (third portions) 23c extending both up and down in the drawing from the portions where both surfaces are in contact with the coils 21 and the inner wall surface of the housing 16.

The stopper parts 23c of the heat-conducting members 23 have the function of coming in contact with the inertia mass 15 when the inertia mass 15 moves translationally in the left-right direction of the drawing as though to overshoot, and deterring the overshooting. Therefore, the thickness of the stopper parts 23c (the dimension in the axial direction of the shaft 17) is formed to be thinner than the other common parts, proportionate to the normal translational motion stroke of the inertia mass 15. The stopper parts 23c also have the function of coming in contact with the inertia mass 15 and preventing excessive slanting when the inertia mass 15 oscillates and tilts relative to the shaft 17. Therefore, the length of the stopper parts 23c (the dimension in the direction orthogonal to the axial direction of the shaft 17) is a dimension that enables contact when the inertia mass 15 is excessively tilted.

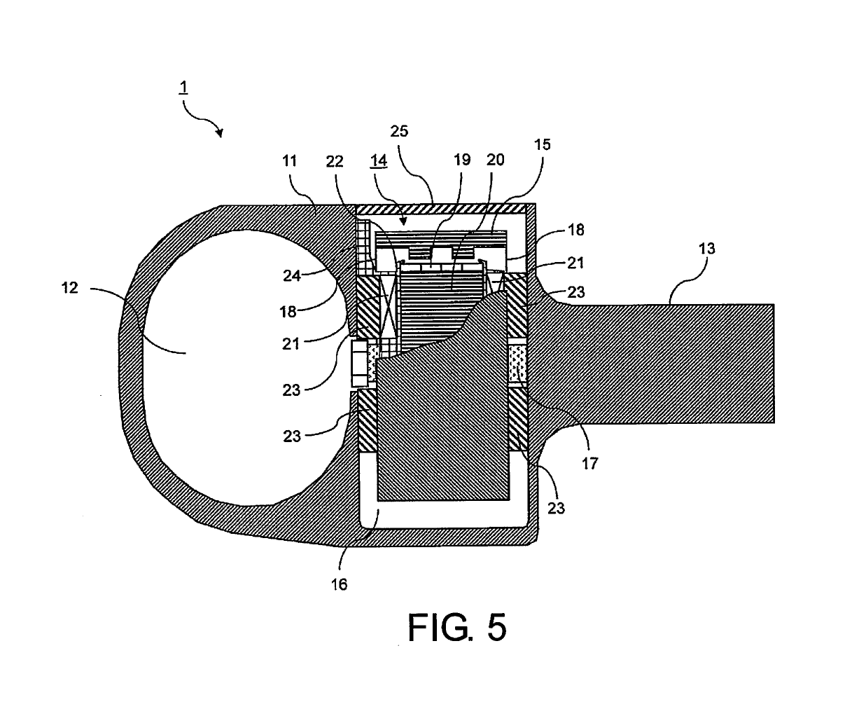

FIG. 5 is a partially cut-away cross-sectional view showing a vehicular antivibration device 1 according to yet another embodiment of the present invention. This embodiment differs from the embodiments described above in that connectors 24 for supplying electric power to the coils 21 and the heat-conducting members 23 are integrally molded, but the configuration is otherwise similar. Specifically, connectors 24 connected to electric power lines in order to supply electric power to the coils 21 are integrally molded on the heat-conducting members 23 of the present example, therefore increasing the heat capacity of the heat-conducting members 23. As a result, the effect of dispelling heat to the torque rod 11 is further increased.

When the connectors 24 are integrally molded on the heat-conducting members 23, elastic members such as rubber may also be added to the connectors 24, on the sides facing the inner wall surface of the housing 16 of the torque rod 11. Doing so causes not only the heat-conducting members 23 but also the connectors 24 to be in contact with the inner wall surface of the housing 16, therefore increasing heat transfer by increasing contact surface area.

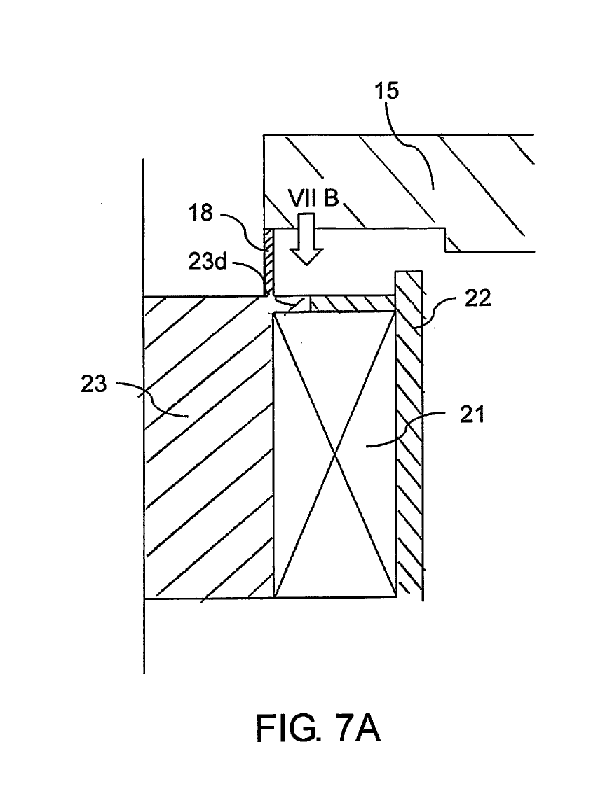

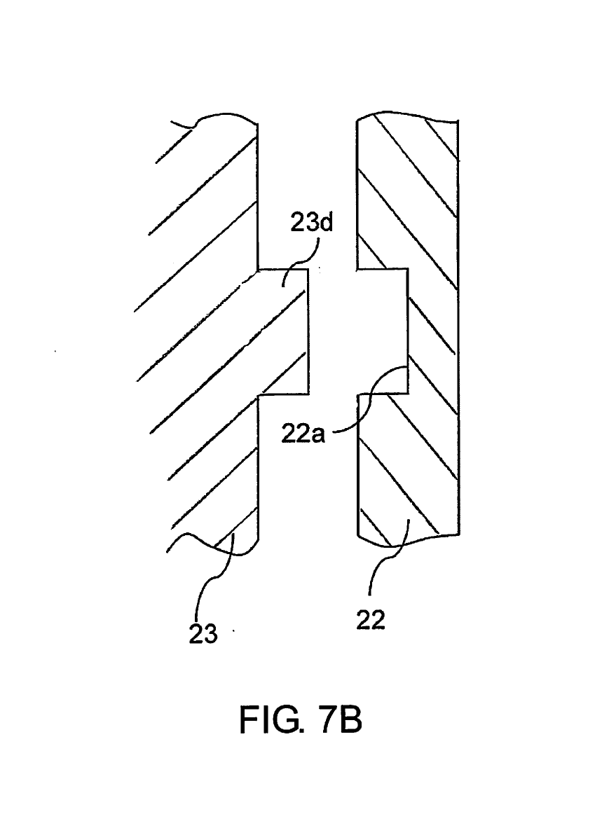

FIGS. 7A and 7B are partially cut-away cross-sectional views showing a vehicular antivibration device 1 according to yet another embodiment of the present invention. This embodiment differs from the embodiments described above in terms of the securing structure of the heat-conducting members 23, but the configuration is otherwise similar. FIG. 7A is an enlarged cross-sectional view around a heat-conducting member 23, and FIG. 7B is a view indicated by arrow VIIB of FIG. 7A. In the present example, to secure the heat-conducting members 23, concavities 22a are formed in the bobbins 22 as shown in FIG. 7B, and convexities 23d that engage in the concavities 22a are formed in the heat-conducting members 23. The heat-conducting members 23 are secured by engaging the convexities 23d of the heat-conducting members 23 in the concavities 22a of the bobbins 22 along the outer peripheries of the coils 21, as shown in FIG. 7A, so as to enable assembly to be easier.

As described above, the following effects are achieved with the vehicular antivibration device 1 of the present example.

(1) In the vehicular antivibration device 1 of the present example, because the heat-conducting members 23 are provided, the heat energy generated by the coils 21 is readily conducted to the torque rod 11 via the heat-conducting members 23, the amount of heat transferred to the permanent magnet 19 can be reduced, and the effect of demagnetization by increased temperature can be suppressed. In addition, due to the heat-conducting members 23 being disposed in proximity to the contours of the coils 21, slackening of the winding of the coils 21 can be prevented.

(2) According to the vehicular antivibration device 1 of the present example, because the reference dimension in the reciprocating direction of the heat-conducting members 23 accounts for a stack-up tolerance that is less than the design-center value of the torque rod 11 and the actuator 14, the dimension L from the inner wall surface of the housing 16 of the torque rod 11 to the sides facing the coils 21 is inevitably less than the thickness of the heat-conducting members 23, the inner wall surface of the housing 16 and the coils 21 can be firmly bonded together, and, as a result, heat conduction performance can be improved.

(3) According to the vehicular antivibration device 1 of the present example, the heat-conducting members 23 are configured from an elastic material and are disposed using the elastic deformation thereof, thereby easily bonding and securing the coils 21 and the inner wall surface of the housing 16 together, and as a result, heat conduction performance can be improved.

(4) According to the vehicular antivibration device 1 of the present example, pressure-fitting the heat-conducting members 23 causes the coils 21 and the inner wall surface of the housing 16 to be easily bonded and secured together, and as a result, heat conduction performance can be improved.

(5) According to the vehicular antivibration device 1 of the present example, using a metal material of high heat conductivity in the heat-conducting members 23 makes it easier for the heat energy generated in the coils 21 to be transferred to the torque rod 11, using a non-metal insulating material such as rubber or a resin in the material of the sides facing the coils 21 creates insulation, and making the thickness t1 of the insulating material portions 23b less than the thickness t2 of the bobbins 22 can improve the performance of heat conduction to the torque rod 11.

(6) According to the vehicular antivibration device 1 of the present example, the bonding structure of the heat-conducting members 23 and the coils 21 can be easily formed by using a molding method such as molded coils.

(7) According to the vehicular antivibration device 1 of the present example, internal interference caused by excessive translational motion can be avoided by making the cross sections of the heat-conducting members 23 into the cross-sectional shapes of the stopper parts 23c which come in contact with the inertia mass 15 during the maximum translation of the actuator 14.

(8) According to the vehicular antivibration device 1 of the present example, internal interference in rotation mode can be avoided by giving the stopper parts 23c of the heat-conducting members 23 dimensions so as to come in contact with the inertia mass 15 when the actuator 14 is at the maximum tilt angle.

(9) According to the vehicular antivibration device 1 of the present example, due to the connectors 24 being integrally molded on the heat-conducting members 23, the total heat capacity of the heat-conducting members 23 is increased, and the performance of conducting heat to the torque rod 11 is improved.

(10) According to the vehicular antivibration device 1 of the present example, the outer surfaces of the connectors 24 integrally molded on the heat-conducting members 23 are firmly bonded with the inner wall surface of the housing 16 of the torque rod 11, whereby the heat transfer surface area can be increased.

(11) According to the vehicular antivibration device 1 of the present example, the heat-conducting members 23 are disposed in proximity to the contours of the coils 21, whereby the heat energy generated in the coils 21 is readily conducted to the torque rod 11 via the heat-conducting members 23, and the ease of assembling is improved by a securing structure using concave/convex engagement.

1. A vehicular antivibration device comprising:
a torque rod having a first end and a second end, the first end being configured to be connected to a vehicle body and the second end being configured to be connected to a vibration source; and
an actuator disposed between the first end and the second end of the torque rod, including an inertia mass supported on the torque rod, and configured to cause the inertia mass to reciprocate in the axial direction of the torque rod,
the actuator comprising
a magnetic core,
a coil wound around the outer periphery of the magnetic core, the magnetic core forming a magnetic path for the coil
a permanent magnet facing the inertia mass and disposed on the magnetic core, and
a heat-conducting member disposed so as to contact the coil and the torque rod.

2. The vehicular antivibration device according to claim 1, wherein
the torque rod includes a contact surface that is in contact with the heat-conducting member, the coil includes a contact surface, and the contact surface of the torque rod and the contact surface of the coil are disposed so as to have a predetermined distance therebetween, the predetermined distance being set on the basis of a dimension including a stack-up tolerance that is less than the design-center value of the torque rod and the actuator.

3. The vehicular antivibration device according to claim 1, wherein
the heat-conducting member is configured so as to be at least one of separate from the actuator and integrated with the actuator, and is secured between the coil and the torque rod by intrinsic elastic deformation.

4. The vehicular antivibration device according to claim 1, wherein
the heat-conducting member is configured so as to be at least one of separate from the actuator and integrated with the actuator, and is secured between the coil and the torque rod by pressure-fitting.

5. The vehicular antivibration device according to claim 1, further comprising
a bobbin surrounding the magnetic core,
the heat-conducting member having a first portion in contact with the torque rod and formed from a metal material, and a second portion in contact with the coil and formed from a non-metal insulating material, and
a dimension of the second portion in an axial direction of the torque rod is shorter than a dimension in an axial direction of a bobbin.

6. The vehicular antivibration device according to claim 1, wherein
the heat-conducting member is at least partially integrally molded with the coil by only a non-metal insulating material.

7. The vehicular antivibration device according to claim 5, wherein
the heat-conducting member has a third portion contacting the torque rod and not contacting the coil, and
a surface of the third portion on a side opposite a surface of the heat-conducting member in contact with the torque rod is configured to stop reciprocation of the inertia mass.

8. The vehicular antivibration device according to claim 7, wherein
third portion has a dimension in a direction orthogonal to the axial direction of the torque rod that enables the inertia mass to contact the third portion when at a maximum tilt angle.

9. The vehicular antivibration device according to claim 1, further comprising
a connector configured to supply electric power to the coil, and being integrally molded with the heat-conducting member.

10. The vehicular antivibration device according to claim 9, wherein
an elastic member is disposed on a torque rod side of an outer surface of the connector, and is integrally molded with the heat-conducting member.

11. The vehicular antivibration device according to claim 1, further comprising
a bobbin surrounding the magnetic core, and having concavities or convexities formed in the bobbin,
the heat-conducting member having convexities or concavities on sides facing the coil and being secured by engaging the concavities or convexities in the bobbin.

12. The vehicular antivibration device according to claim 2, wherein
the heat-conducting member is configured so as to be at least one of separate from the actuator and integrated with the actuator, and is secured between the coil and the torque rod by intrinsic elastic deformation.

13. The vehicular antivibration device according to claim 2, wherein
the heat-conducting member is configured so as to be at least one of separate from the actuator and integrated with the actuator, and is secured between the coil and the torque rod by pressure-fitting.

14. The vehicular antivibration device according to claim 2, further comprising
a bobbin surrounding the magnetic core,
the heat-conducting member having a first portion in contact with the torque rod and formed from a metal material, and a second portion in contact with the coil and formed from a non-metal insulating material, and
a dimension of the second portion in an axial direction of the torque rod is shorter than a dimension in an axial direction of a bobbin.

15. The vehicular antivibration device according to claim 2, wherein
the heat-conducting member is at least partially integrally molded with the coil by only a non-metal insulating material.

16. The vehicular antivibration device according to claim 2, further comprising
a connector configured to supply electric power to the coil, and being integrally molded with the heat-conducting member.

17. The vehicular antivibration device according to claim 2, further comprising
a bobbin surrounding the magnetic core, and having concavities or convexities formed in the bobbin,
the heat-conducting member having convexities or concavities on sides facing the coil and being secured by engaging the concavities or convexities in the bobbin.
